(19) United States
(12) Patent Application Publication
(10) Pub. No.: US 2010/0250479 A1
(43) Pub. Date: Sep. 30, 2010

(54) INTELLECTUAL PROPERTY DISCOVERY AND MAPPING SYSTEMS AND METHODS

(75) Inventor: Stephen R. Carter, Spanish Fork, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/415,975

(22) Filed: Mar. 31, 2009

(51) Int. Cl. G06N 5/02; G06F 17/30; G06Q 10/00; G06Q 50/00

(52) U.S. Cl. 706/46; 705/10; 707/E17.005

(57) ABSTRACT

An apparatus can include an information gathering module, a semantic abstract generation module, and an intellectual property space identification module. The information gathering module can retrieve information pertaining to intellectual property activities within a particular technical field. The semantic abstract generation module can generate semantic abstracts based on the information retrieved by the information gathering module. The intellectual property space identification module can perform an evaluation of the particular technical field based on the generated semantic abstracts.

### CROSS-REFERENCE TO RELATED APPLICATIONS

This application is related to co-pending and commonly owned U.S. patent application Ser. No. 11/929,678, titled “CONSTRUCTION, MANIPULATION, AND COMPARISON OF A MULTI-DIMENSIONAL SEMANTIC SPACE,” filed on Oct. 30, 2007, which is a divisional of U.S. patent application Ser. No. 11/562,337, filed on Nov. 21, 2006, which is a continuation of U.S. patent application Ser. No. 09/512,963, filed Feb. 25, 2000, now U.S. Pat. No. 7,152,031, issued on Dec. 19, 2006. All of the foregoing applications are fully incorporated by reference herein.

This application is also related to co-pending and commonly owned U.S. patent application Ser. No. 11/616,154, titled “SYSTEM AND METHOD OF SEMANTIC CORRELATION OF RICH CONTENT,” filed on Dec. 26, 2006, which is a continuation-in-part of U.S. patent application Ser. No. 11/563,659, titled “METHOD AND MECHANISM FOR THE CREATION, MAINTENANCE, AND COMPARISON OF SEMANTIC ABSTRACTS,” filed on Nov. 27, 2006, which is a continuation of U.S. patent application Ser. No. 09/615,726, filed on Jul. 13, 2000, now U.S. Pat. No. 7,197,451, issued on Mar. 27, 2007; and is a continuation-in-part of U.S. patent application Ser. No. 11/468,684, titled “WEB-ENHANCED TELEVISION EXPERIENCE,” filed on Aug. 30, 2006; and is a continuation-in-part of U.S. patent application Ser. No. 09/691,629, titled “METHOD AND MECHANISM FOR SUPERPOSITIONING STATE VECTORS IN A SEMANTIC ABSTRACT,” filed on Oct. 18, 2000, now U.S. Pat. No. 7,389,225, issued on Jun. 17, 2008; and is a continuation-in-part of U.S. patent application Ser. No. 11/554,476, titled “INTENTIONAL-STANCE CHARACTERIZATION OF A GENERAL CONTENT STREAM OR REPOSITORY,” filed on Oct. 30, 2006, which is a continuation of U.S. patent application Ser. No. 09/653,713, filed on Sep. 5, 2000, now U.S. Pat. No. 7,286,977, issued on Oct. 23, 2007. All of the foregoing applications are fully incorporated by reference herein.

This application is also related to co-pending and commonly owned U.S. patent application Ser. No. 09/710,027, titled “DIRECTED SEMANTIC DOCUMENT PEDIGREE,” filed on Nov. 7, 2000, which is fully incorporated by reference herein.

This application is also related to co-pending and commonly owned U.S. patent application Ser. No. 11/638,121, titled “POLICY ENFORCEMENT VIA ATTESTATIONS,” filed on Dec. 13, 2006, which is a continuation-in-part of U.S. patent application Ser. No. 11/225,993, titled “CRAFTED IDENTITIES,” filed on Sep. 14, 2005, and is a continuation-in-part of U.S. patent application Ser. No. 11/225,994, titled “ATTESTED IDENTITIES,” filed on Sep. 14, 2005. All of the foregoing applications are fully incorporated by reference herein.

This application is also related to and fully incorporates by reference the following co-pending and commonly owned patent applications: U.S. patent application Ser. No. 12/267,279, titled “PREDICTIVE SERVICE SYSTEMS,” filed on Nov. 7, 2008; U.S. patent application Ser. No. 12/346,657, titled “IDENTITY ANALYSIS AND CORRELATION,” filed on Dec. 30, 2008; U.S. patent application Ser. No. 12/346,662, titled “CONTENT ANALYSIS AND CORRELATION,” filed on Dec. 30, 2008; and U.S. patent application Ser. No. 12/346,665, titled “ATTRIBUTION ANALYSIS AND CORRELATION,” filed on Dec. 30, 2008.

This application also fully incorporates by reference the following commonly owned patents: U.S. Pat. No. 6,108,619, titled “METHOD AND APPARATUS FOR SEMANTIC CHARACTERIZATION OF GENERAL CONTENT STREAMS AND REPOSITORIES,” U.S. Pat. No. 7,177,922, titled “POLICY ENFORCEMENT USING THE SEMANTIC CHARACTERIZATION OF TRAFFIC,” and U.S. Pat. No. 6,650,777, titled “SEARCHING AND FILTERING CONTENT STREAMS USING CONTOUR TRANSFORMATIONS,” which is a divisional of U.S. Pat. No. 6,459,809.

### TECHNICAL FIELD

The disclosed technology pertains to semantic abstracts, and more particularly to the use of semantic abstracts in connection with various types of intellectual property discovery and mapping.

### BACKGROUND

As used herein, intellectual property activity includes intellectual property protection, such as issued patents and patent applications (published and unpublished), in the United States and/or other countries. Intellectual property activity also includes barriers to new intellectual property protection, such as printed publications (e.g., white papers and technical reports).

The term “blue ocean space,” as used herein, refers to an intellectual property semantic space that has little to no intellectual property activity (e.g., with respect to the competition) therein. In other words, a blue ocean space is typically a technical field or subset of a technical field (or portion thereof) that has no more than an insignificant amount of intellectual property activity owned by one or more competitors therein. For example, a highly technical field such as genetics may have a wide variety of sub-areas that each have little to no intellectual property protection (or barriers to such protection) by the competition in place.

Blue ocean spaces may be considered ripe for participant entities (e.g., companies and/or individuals) to not only cultivate new advances in the technology but also to possibly pursue new types of intellectual property protection for the advances within the technical field.

The term “red ocean space,” as used herein (and in contrast to “blue ocean space”), refers to an intellectual property semantic space that has a significant amount of intellectual property activity (e.g., by the competition) therein. For example, consider a certain technical field such as a printer-related technology, or a subset of the technical field, such as a certain type of printer driver technology. The technical field or subset thereof may be considered a red ocean space if one or more entities (e.g., companies and/or individuals) have created a significant amount of intellectual property protection in the technical field or subset thereof. However, technical advances in the particular field can create a blue ocean space.

However, a need remains for a way to identify red oceans and/or blue oceans and to generate intellectual property strategies in light of the identified red oceans and/or blue oceans.

### SUMMARY

Embodiments of the disclosed technology can involve the use of semantic abstracts in order to identify for a user entity certain blue ocean opportunities in which the user entity may pursue technical advances and possibly seek intellectual property protection for the technical advances.

Embodiments of the disclosed technology can also include the use of semantic abstracts to identify for a user entity one or more red ocean spaces involving certain technologies that the competition of the user entity may be pursuing. Thus, such embodiments advantageously enable the user entity to make informed decisions as to what, if any, technical advances the user entity can and should pursue within the technical area.

Embodiments of the disclosed technology can provide various types of computer-implemented methods and mechanisms that can advantageously enable a user entity to find research areas that are close to existing enterprise intellectual property.

Embodiments of the disclosed technology can also provide various types of computer-implemented methods and mechanisms that can advantageously enable a user entity to find research areas that have or appear to have little to no intellectual property protection (e.g., by the competition) in place.

Embodiments of the disclosed technology can also provide various types of computer-implemented methods and mechanisms that can advantageously enable a user entity to find research areas that may have or appear to have little to no intellectual property protection in place but are close to existing enterprise intellectual property.

Embodiments of the disclosed technology can provide various types of computer-implemented methods and mechanisms that can advantageously detect where intellectual property is being fenced in along with mechanisms for identifying the intellectual property holdings of one or more competitors such that the investigating entity can use the identified intellectual property holdings to impact one or more of the competitors. For example, certain embodiments can include determining whether a certain competitor is pursuing and/or securing intellectual property protection in a particular technical area of interest.

Embodiments of the disclosed technology can also provide various types of computer-implemented methods and mechanisms to enable an investigating entity to determine where intellectual property fences might be built in order to achieve an advantageous position with respect to the intellectual property holdings of the competition.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a first example of an intellectual property discovery and mapping system in accordance with embodiments of the disclosed technology. In the example, the intellectual property discovery and mapping system has an information gathering module, a semantic mapping module, a system management module, a blue/red ocean space identification module, and a report generation module.

FIG. 2 shows an example of an information gathering module, such as the information gathering module of FIG. 1, in accordance with embodiments of the disclosed technology. In the example, the information gathering module can interactively access and gather information from a wide variety of sources, such as patent-related and non-patent-related documents.

FIG. 3 shows an example of an intellectual property semantic space in accordance with embodiments of the disclosed technology. In the example, the intellectual property semantic space has various types of intellectual property activity (e.g., by one or more competitors), as well as blue ocean spaces and red ocean spaces, therein.

FIG. 4 is a flowchart of a first exemplary method of performing an intellectual property space analysis by using an intellectual property discovery and mapping system (e.g., the intellectual property discovery and mapping system of FIG. 1) in accordance with embodiments of the disclosed technology.

FIG. 5 shows a second example of an intellectual property discovery and mapping system in accordance with embodiments of the disclosed technology. In the example, the intellectual property discovery and mapping system has an information gathering module, at least two semantic mapping modules, a system management module, a blue/red ocean space identification module, and a report generation module.

FIG. 6 shows an example of an intellectual property space in which an intellectual property fence can be pursued in accordance with embodiments of the disclosed technology.

FIG. 7 is a flowchart of a second exemplary method of performing an intellectual property space analysis by using an intellectual property discovery and mapping system (e.g., the intellectual property discovery and mapping system of FIG. 5) in accordance with embodiments of the disclosed technology.

FIG. 8 shows a flowchart illustrating an example of a method of constructing a semantic abstract for a document based on dominant phrase vectors.

FIG. 9 shows a flowchart illustrating an example of a method of constructing a semantic abstract for a document based on dominant vectors.

FIG. 10 shows a flowchart illustrating an example of a method of comparing two semantic abstracts and recommending a second content that is semantically similar to a content of interest.

### DETAILED DESCRIPTION

A business entity (e.g., company or individual person) generally wishes to adequately protect its intellectual property (e.g., via issued patents and/or patent applications). However, the protection of the business entity's intellectual property may be particularly valuable in a marketplace that is crowded with competitors. In such a context, for example, the entity can use its intellectual property protection to strategically protect its product innovations.

A typical business enterprise will actively look for new markets in blue ocean spaces (e.g., markets that remain largely untapped in terms of intellectual property activity). New products within such blue ocean spaces can often provide the business enterprise with a significant advantage if the business enterprise is the first entity to develop products in the area, particularly if the products are adequately protected from duplication by competitors.

Embodiments of the disclosed technology can provide computer-implemented methods and mechanisms for finding such blue ocean space market opportunities, as described in detail below. Certain embodiments can also include determining how close a blue ocean space market is to existing business enterprise intellectual property activity. Such embodiments can also identify past and/or current research that may be pertinent to the identified blue ocean space market.

A business entity will often seek to protect intellectual property in such a way that it is said to fence in another competitor's intellectual property, especially if such intellectual property fences will provide the business entity with a significant advantage over the competitor's product in the marketplace. However, the obtaining of patents (or filing of patent applications) by a business entity in order to protect the entity's intellectual property is generally minimized or outright nullified when a competitor procures their own patents (or files their own patent applications) that create such an intellectual property fence for the competitor.

Embodiments of the disclosed technology can provide computer-implemented methods and mechanisms for identifying boundaries of a business entity's intellectual property protection as well as areas where a competitor's intellectual property may begin to create such intellectual property fences. Embodiments of the disclosed technology can also identify areas within a competitor's intellectual property portfolio in which the business entity might attempt to build its own intellectual property fences in order to achieve an advantage within the marketplace.

### Blue Ocean Intellectual Property Space Discovery

An investigating entity (e.g., a business enterprise) will often pursue various types of intellectual property protection such as issued patents, published and/or unpublished patent applications, trade secrets, etc. Embodiments of the disclosed technology can include evaluating the existing technologies for a given business entity and generating semantic abstracts or vectors in the semantic space that are based on the evaluations performed. Semantic abstracts can also be generated based on evaluations of one or more related technologies for competitors. In certain embodiments, a comparison can be made between the semantic abstracts generated for the entity and the semantic abstracts generated with respect to the competition.

Results of the comparisons between the semantic abstracts generated for the entity and those generated with respect to the competition can be used to determine areas that the entity may desire to exploit (e.g., blue ocean spaces) that are either within current areas of research or areas that are not currently occupied. For example, in certain embodiments, these comparisons may be thought of as Venn diagrams against current work that can be used to identify areas within the field that are not yet a part of any substantial intellectual property holdings.

The results can also be used to identify areas that the entity may wish to exploit but in which the entity might be limited by competitors (e.g., by intellectual property fences). Alternatively, or in addition thereto, the results can be used to identify areas within the intellectual property space in which the entity could seek to fence in other competitors by building its own intellectual property fences.

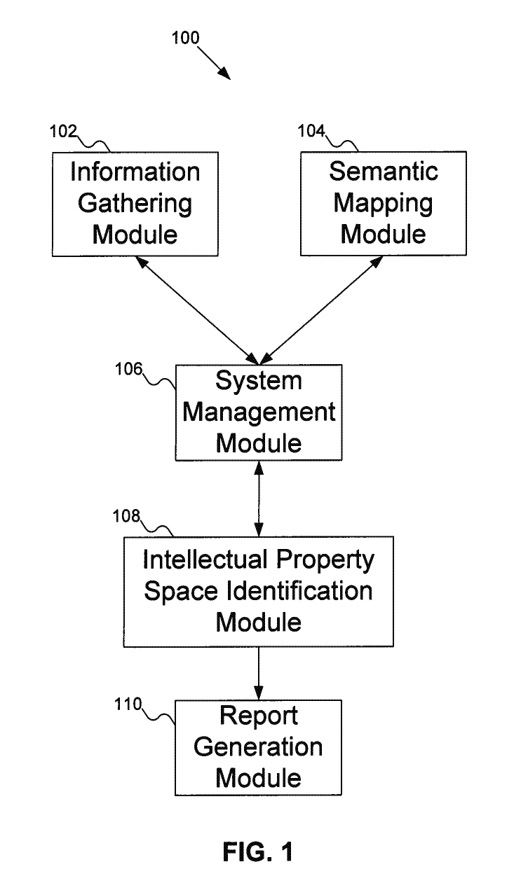

FIG. 1 illustrates a first example of an intellectual property discovery and mapping system 100 in accordance with the disclosed technology. A user entity can designate a particular technical area or sub-area of interest. For example, if the user entity is a company whose products are primarily computer printers, the entity may wish to designate computer printers as the technical area of interest. The user entity may wish to focus in on more specific sub-areas such as printer drivers. Alternatively, the user entity may wish to expand the technical area to that of printing technologies in general.

An information gathering module 102 can be utilized to search some or all issued patents, published patent applications, white papers, and various other types of publicly available intellectual property-related documents that fall within or are at least connected to the technical area or sub-area designated by the user entity.

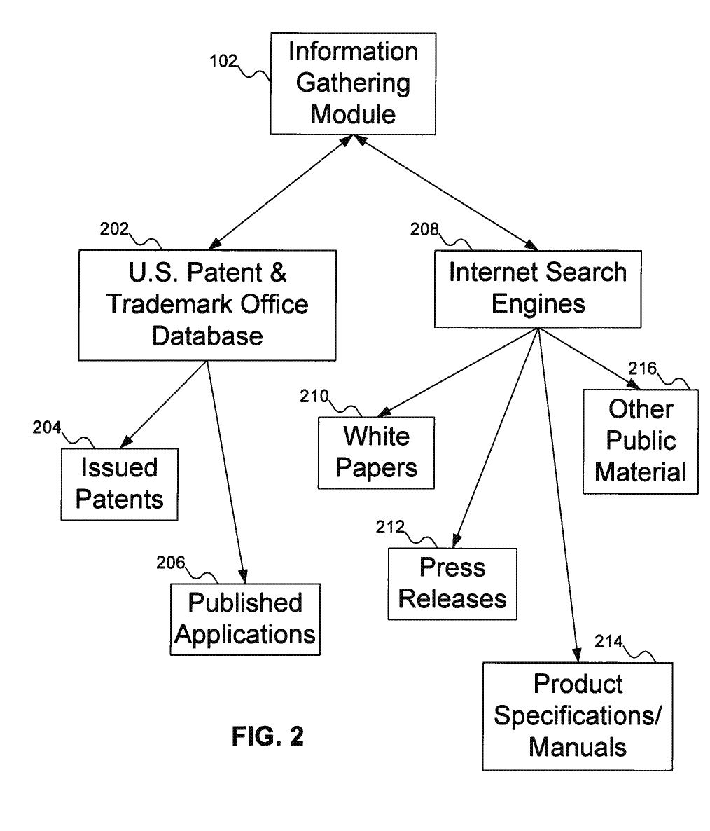

FIG. 2 illustrates an example of the information gathering module 102. In the example, the information gathering module 102 can search the U.S. Patent & Trademark Office database 202 for issued patents 204 and/or published patent applications 206 that pertain to the printer technologies designated by the user. The information gathering module 102 can also perform Internet searches 208 (using search engines such as Yahoo! or Google) to identify white papers 210, press releases 212, product specifications and/or product manuals 214, and other types of publicly available material 216 pertaining to the printing technology areas or sub-areas designated by the user entity.

In certain embodiments, a user entity can provide direction as to what sources the information gathering module 102 should search. For example, the user entity may direct the information gathering module 102 to focus solely on patent-related documents (e.g., issued patents and published applications). Alternatively, the user entity may direct the information gathering module 102 to concentrate primarily or solely on non-patent documents such as research-related documents (e.g., published white papers).

Returning to FIG. 1, a semantic mapping module 104 can be used create a first semantic mapping of the intellectual property pertaining to the technical area or sub-area designated by the user entity. For example, the semantic mapping module 104 can generate virtually any number of semantic abstracts based on the information retrieved by the information gathering module 102. The semantic mapping module 104 can generate semantic abstracts in accordance with various semantic abstract generation techniques such as those described in detail below. Once generated by the semantic mapping module 104, the semantic mapping can then be stored, for example, in local memory (e.g., at the user entity's computer system) or remotely (e.g., at a remote server).

A system management module 106 can be used to manage various aspects pertaining to the operation of and information flow between the gathering module 102 and the semantic mapping module 104. For example, the system management module 106 can receive from the information gathering module 102 results of the searches and pass the results on (e.g., filtered or unfiltered) to the semantic mapping module 104. The system management module 106 can also control the flow of information between the semantic mapping module 104 and a blue/red ocean space identification module 108.

The blue/red ocean space identification module 108 can be used to identify blue and/or red ocean spaces within the intellectual property space of the technical areas or sub-areas designated by the investigating entity. If multiple semantic mappings were generated, they can be aggregated. The result of such a combination would be a semantic space wherein the distance between the various semantic abstracts can be measured. Because the semantic abstracts have a distance from one another, the investigating entity (via a user interface, for example) can select a radius of influence from the entity's own intellectual property protection and thus discover what other intellectual property (e.g., a competitor's intellectual property protection) is close by.

Based on the semantic abstracts generated by the semantic mapping module 104, the blue/red ocean space identification module 108 can identify areas having little to no intellectual property activity and flag those areas as blue ocean spaces. For example, the blue/red ocean space identification module 108 can search for any blue ocean spaces (e.g., total nullities) within the intellectual property space. A space identified as a blue ocean space thus represents an area into which the business enterprise may want to expand based on certain considerations, such as whether the entity's own intellectual property is applicable, whether there is research to support the development of the entity's products, and to what extent there are any competitors in the area with intellectual property protection.

Consider an example in which a business entity wishes to pursue certain intellectual property protection that would not be particularly close to existing research. In the example, there are no known intellectual property protections so far in the corresponding semantic space. In other words, the system does not identify any patents or patent publications owned by competitors or others that have been included in the generated semantic mappings. In the example, the business enterprise is said to have discovered an area in which it should be able to freely pursue the desired intellectual property protection.

The blue/red ocean space identification module 108 can also identify areas having a significant amount of intellectual property activity (e.g., above a predetermined threshold) and flag those areas as red ocean spaces. Thus, the business entity may wish to avoid furthering any product development in those areas because intellectual property protection may not be available to the enterprise. Furthermore, the enterprise may desire to not risk infringing on a competitor's protected intellectual property space.

In certain implementations of the disclosed technology, such as the example illustrated in FIG. 1, the blue/red ocean space identification module 108 can include a single module that can perform both blue ocean space identification and red ocean space identification (e.g., concurrently or separately). Alternatively, the blue/red ocean space identification module 108 can include two or more modules, where one module is devoted to identifying blue ocean spaces within the intellectual property space and another module is devoted to red ocean spaces within the intellectual property space.

A report generation module 110 can generate a report based on the determinations and flaggings by the blue/red ocean space identification module 108. The report generation module 110 can also transmit (e.g., graphically display) the generated report to the user entity. Thus, evaluations based on measurements pertaining to the semantic mapping can be effectively used by the business entity to discover areas within the intellectual property space that may be within a certain semantic distance to (e.g., close to or far away from) aspects of the semantic abstracts that belong to the intellectual property portfolio of the competition. In certain embodiments, the generated report can include a SQL database such that the business entity can perform various types of database-related activities in connection with the information contained in the generated report.

In certain embodiments, the intellectual property discovery and mapping system 100 can be used separately for different competitors. For example, a user entity may use the intellectual property discovery and mapping system 100 to generate a semantic mapping for a first competitor within the specified technical area and then use the intellectual property discovery and mapping system 100 to generate a semantic mapping for a second competitor within the same industry or field. The user entity can direct the intellectual property discovery and mapping system 100 to treat the two semantic mappings separately or to aggregate them so as to obtain a “snapshot” of the intellectual property activity (e.g., fences) established by the identified competition.

Alternatively, the user entity can direct the intellectual property discovery and mapping system 100 to perform the semantic mapping for different technical areas or sub-areas or for different competitors, where one competition may only partially overlap the second competitor with respect to the targeted intellectual property space. Thus, the intellectual property discovery and mapping system 100 can effectively provide the user entity with a “snapshot” as to the intellectual property activity within the fields or sub-fields of the particular industry.

In certain implementations of the disclosed technology, the user entity can use the intellectual property discovery and mapping system 100 to generate a semantic mapping for its own intellectual property activity within the technical area. In such embodiments, the intellectual property discovery and mapping system 100 can be used to partition the business entity's trade secrets, issued patents, and the like into multiple semantic maps in order to enable a more fine-grained investigation against the previously generated semantic maps, for example. For example, the intellectual property discovery and mapping system 100 can partition the vector space along organizational lines (e.g., by research team).

In certain embodiments, the investigating entity can use the intellectual property discovery and mapping system 100 to create semantic maps by aggregating or combining various semantic mappings in order to find research that is not particularly close to the entity's own intellectual property holdings or to the intellectual property holdings of the entity's competitors. If the intellectual property discovery and mapping system 100 discovers that neither the investigating entity nor any of the entity's competitors has any significant amount of intellectual property protection in the area defined by the research being investigated, such an area would be flagged as a blue ocean area and the corresponding research would be identified as a blue ocean opportunity for the business enterprise.

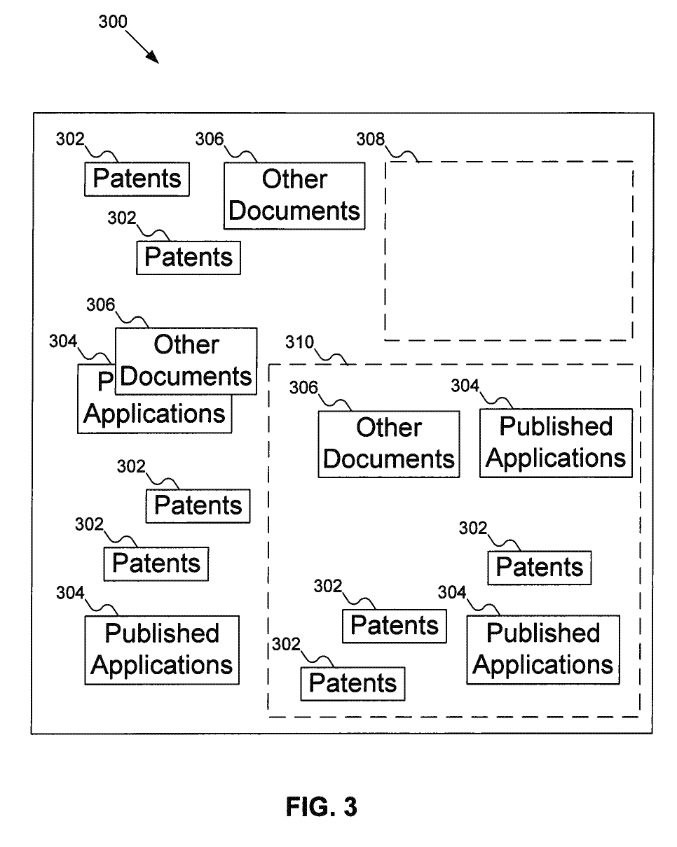

FIG. 3 illustrates an example of the intellectual property space 300 of a given technical area or sub-area (or portion thereof). Within the intellectual property space 300 are various types of intellectual property activity (e.g., corresponding to the competition), such as issued patents 302, published patent applications 304, and other publicly-available documents 306 as described herein. A blue ocean area 308 is an area within the intellectual property space 300 in which little or no intellectual property activity is currently taking place. A red ocean area 310 is an area with the intellectual property space 300 in which a significant amount of intellectual property is currently taking place.

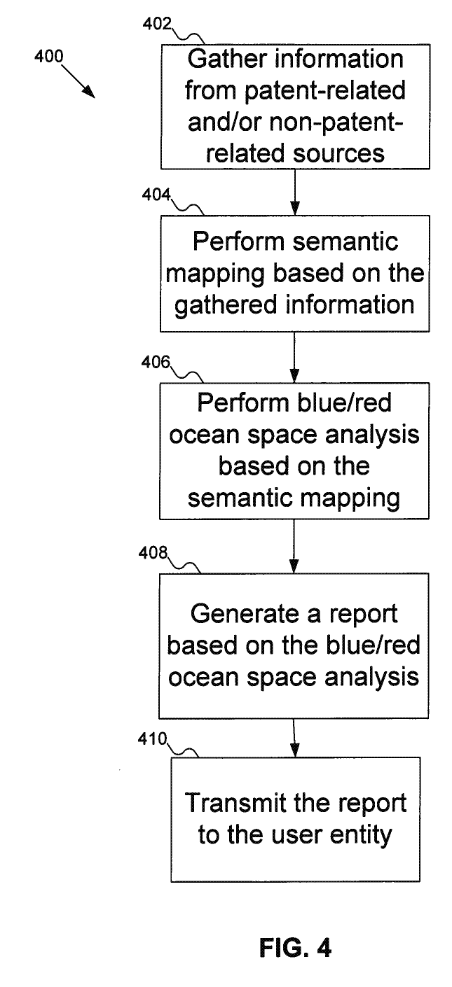

FIG. 4 is a flowchart of a first exemplary method 400 of performing an intellectual property space analysis in accordance with embodiments of the disclosed technology. At 402, information is gathered (e.g., by the information gathering module 102 of FIG. 1) from various types of patent-related documents, such as issued patents and published patent applications, and from various types of non-patent-related documents such as white papers, for example.

At 404, a semantic mapping is performed (e.g., by the semantic mapping module 104 of FIG. 1). For example, a number of semantic abstracts can be generated based on the information gathered at 402. The semantic abstracts can be generated in accordance with virtually any semantic abstract generation technique including, but not limited to, those described below.

At 406, a blue/red ocean space analysis is performed in light of the semantic mapping generated at 404. For example, a blue ocean space analysis can be performed to identify areas within the semantic space that demonstrate little to no intellectual property activity (e.g., issued patents or published patent applications) by the user entity's competitors. Such spaces would thus be flagged as blue ocean spaces. Also, the blue/red ocean space identification module 108 can be run iteratively such that a new or updated analysis in performed continually or in response to an event such as a request by the user entity or an external alert pertaining to new intellectual property activity that has appeared in the intellectual property space since the last analysis.

Alternatively, or in addition to the blue ocean space analysis, a red ocean space analysis can be performed in order to identify areas within the semantic space that demonstrate a significant amount of intellectual property activity by the entity's competition. For example, if the number of issued patents and/or published patent applications exceeds a particular threshold level, then the space can be flagged as a red ocean space, thereby indicating to the user entity that the entity may not want to attempt to enter the space (e.g., pursue new products or features that might be covered by existing intellectual property protection). In certain embodiments, the threshold level can be determined by the user entity. Alternatively, a default value could be established.

At 408, a report can be generated based on the blue and/or red ocean space analysis with respect to the generated semantic mapping. For example, the report can indicate to the user entity whether any blue ocean spaces and/or red ocean spaces were identified within the pertinent semantic space. The report can also indicate a rating for each blue or red ocean space. For example, if a space flagged as a blue ocean space has no known intellectual property activity therein, that space may have the highest rating to indicate that the entity should have an excellent opportunity to pursue its own intellectual property protection within that area.

If there is some intellectual property activity within the space flagged as a blue ocean space, however, the rating assigned to the space can be determined based on an indirect relationship between rating value and amount of activity. In other words, the more intellectual property activity there is within the blue ocean space, the lower the rating. Thus, the user entity can be advantageously advised of a determination as to how worthwhile it might be for the entity to pursue its own intellectual property protection within that space. For example, if there is some overlap between the intellectual property holdings of the investigating entity and that of the competition, the user may be advised that it has an increased chance of strengthening or expanding its holdings.

Once generated, the generated report can be transmitted to the user entity, as shown at 410. For example, the report can be graphically displayed using a graphical user interface (GUI). The generated report can also be stored locally or remotely, for example, for future reference by the entity.

In certain embodiments, the reports generated by the report generation module 110 and transmitted to the business entity can advantageously include a visual representation of the semantic space that identifies where the entity's competitors have at least some intellectual property protection and where the investigating entity has little to no intellectual property protection. For example, blue and red ocean spaces can be color-coded (e.g., blue and red, respectively) within a graphical representation of the entire intellectual property space. The generated report can also identify any pertinent new or ongoing research that might be of interest in that particular area of intellectual property space.

In certain implementations, the semantic mappings can be reversible. That is, the intellectual property discovery and mapping system can take a vector in multi-dimensional space (e.g., a blue ocean space) and determine an area in a linguistic model as to what is described. In the corresponding semantic abstract, a tag in a mark-up can be a reference to the document from which it came. Thus, the system can use the tag inside the semantic abstract to get to the original source material.

By combining different semantic maps that are based on a partitioning of intellectual property, trade secrets, research, etc., the intellectual property discovery and mapping system 100, via the reports generated by the report generation module 110, can advantageously enable the investigating entity to assess or better determine the strength of its own intellectual property holdings as well as the strength of the intellectual property holdings or one or more competitors. The intellectual property discovery and mapping system 100 can also serve to estimate or measure the strength or weakness of a particular research area in which new marketplace opportunities may be pursued by the entity.

Furthermore, the intellectual property discovery and mapping system 100 can advantageously provide the business entity with determinations pertaining to what areas the competitors are currently strengthening their intellectual property holdings. Thus, the business entity is significantly better positioned should the entity desire to move into a blue ocean opportunity. In certain embodiments, the intellectual property discovery and mapping system 100 can also monitor the intellectual property space of the targeted area and alert the investigating entity as to any possible future activity of one or more competitors. For example, the intellectual property discovery and mapping system 100 can be scheduled to run continuously, at certain intervals, or in response to a trigger (e.g., a user-initiated request)

### Competitive Intellectual Property Mapping

Certain implementations of the disclosed technology can include generating a semantic mapping based on a particularly partitioned portion of the intellectual property holdings of the investigating entity. In such embodiments, the result can include an indication as to potential availability of intellectual property holdings for the investigating entity in some predefined granularity. The result can also include an indication as to any potential convergence by the investigating entity and/or the competition to a given technical area. Thus, the system can advantageously provide the user entity with information pertaining to actual or possible trends within the technical area.

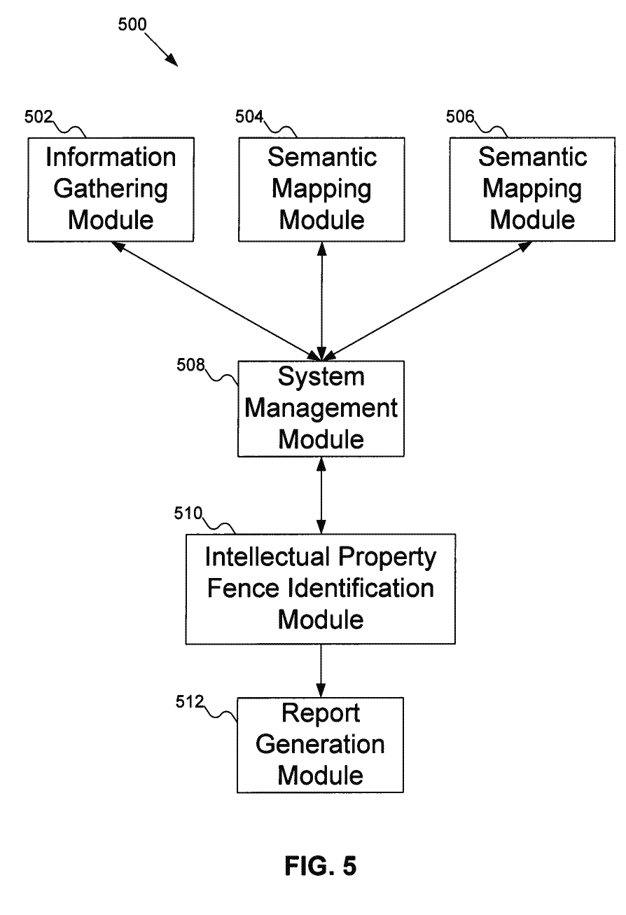

FIG. 5 illustrates a second example of an intellectual property discovery and mapping system 500 in accordance with the disclosed technology. An information gathering module 502 can be utilized to search issued patents, published patent applications, white papers, and various other types of publicly available intellectual property-related documents. The information gathering module 502 is similar in function to the information gathering module 202 of FIG. 2, which is described in detail above.

A first semantic mapping module 504 can be used to create one or more semantic mappings corresponding to the intellectual property holdings of one or more competitors in some predefined granularity. For example, the user entity may wish to generate a single semantic mapping for one competitor within a certain technical area. Alternatively, the user entity may wish to generate a semantic mapping for all of the intellectual property holdings of the business entity's competition within the technical area or sub-area.

A second semantic mapping module 506 can be used to create a semantic mapping corresponding to the intellectual property holdings of the business entity itself. As with the first semantic mapping module 504, the user can direct the second semantic mapping module 506 to create the semantic mapping for a single technical area or sub-area or for virtually any combination of techincal areas and/or sub-areas within those areas.

A system management module 508, similar to the system management module 106 of FIG. 1, can be employed to coordinate operation of the information gathering module 502 as well as both of the semantic mapping modules 504 and 506. One having ordinary skill in the art will recognize that virtually any number of semantic mapping modules may be used an in virtually any combination, and that the arrangement shown in FIG. 5 is for purposes of illustration only. For example, the first semantic mapping module 504 may reside at a remote location whereas the second semantic mapping module 506 may reside locally (e.g., at the user entity's computer system). Also, in certain arrangements, the two semantic mapping modules 504 and 506 may represent different components of a single semantic mapping module.

In the example, an intellectual property fence identification module 510 can effectively combine the semantic mappings generated by the semantic mapping modules 504 and 506 to create a semantic space map in which distances between the intellectual property holdings of one or more competitors and the actual property holdings of the investigating entity can be measured. For example, if one of the measured distances demonstrates a particularly close proximity between the intellectual property held by the investigating entity and that of a competitor, such a measurement may indicate that the competitor is effectively fencing in products and/or intellectual property owned by the investigating entity.

If one of the measure distances is particularly long, however, such a measurement may indicate that the identified products or potential intellectual property holdings of the entity may be prime candidates for the development of intellectual property fences by the entity itself. For example, if the intellectual property holdings of the investigating entity are a significantly long distance away from the competitor, and if the intellectual property holdings of the competitor are a significantly long distance away from those owned by the investigating entity, then such a space is said to be not anticipated by the competition. Thus, by pursuing new intellectual property protection or extending the existing intellectual property holdings of the user entity, the entity may be able to effectively formulate what will be referred to as intellectual property fences within in the competitor's intellectual property holdings.

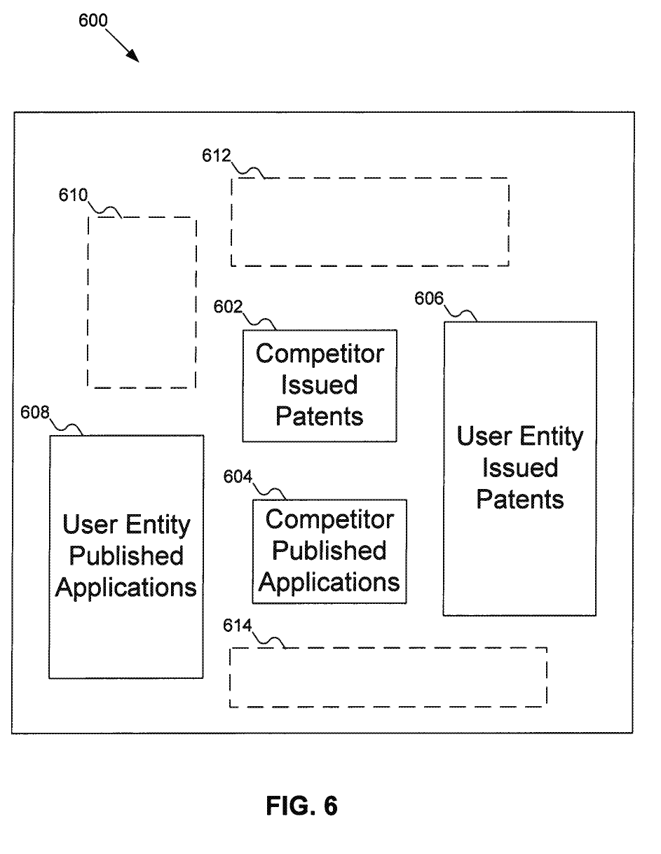

FIG. 6 shows an example of an intellectual property space 600 in which an intellectual property fence can be pursued in accordance with embodiments of the disclosed technology. Within the intellectual property space 600 are various types of intellectual property protection owned by a particular competitor. In the example, the competitor owns several issued patents 602 and several published patent applications 604. Also within the space are several types of intellectual property protection held by the investigating entity. In the example, the investigating entity owns several issued patents 606 and has a number of published (or unpublished) patent applications 608.

The various intellectual property items within the intellectual property space 600 can be arranged in a number of ways. For example, there may be a direct relationship between the similarity of product features and the distance between any intellectual property protection thereof. In the example, the competitor's issued patents 602 and published patent applications 604 are grouped closely together, which signifies that they may all pertain to the same or similar features.

After performing an analysis using the intellectual property discovery and mapping system 500 of FIG. 5, for example, the user entity may receive a report detailing various spaces 610, 612, and 614 within the intellectual property space 600 that substantially fill in the “gaps” of an intellectual property fence surrounding the competitor's issued patents 602 and published applications 604. Thus, if the investigating entity were to pursue intellectual property protection (e.g., by preparing and filing of a certain number of patent applications within the targeted portions 610, 612, and 614 of the intellectual property space 600), the entity could effectively build an intellectual property fence around the competitor's intellectual property holdings. This means that the user entity could limit and possibly even prevent the competitor from expanding their existing intellectual property protection.

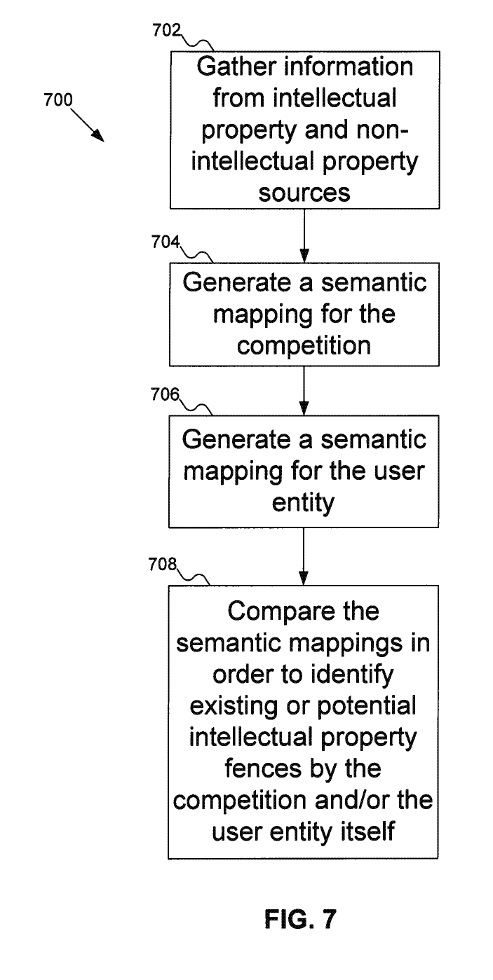

FIG. 7 is a flowchart of a second exemplary method 700 of performing an intellectual property space analysis in accordance with embodiments of the disclosed technology. At 702, information is gathered from a wide variety of intellectual property-related and non-intellectual property-related sources that pertain to a particular technical area or sub-area designated by the investigating entity.

At 704, a first semantic mapping (e.g., a first set of semantic abstracts) is generated for a competitor that may have intellectual property protection in place within the technical area designated by the user entity. In certain embodiments, the first semantic mapping can focus on the technical area rather than the competitor. In other words, the first semantic mapping can be performed with respect to all of the intellectual property activity within the technical area regardless of ownership.

At 706, a second semantic mapping (e.g., a second set of semantic abstracts) is generated for the investigating entity itself. That is, the system (e.g., the intellectual property discovery and mapping system 500 of FIG. 5) can search all of the user entity's intellectual property holdings in order to generate semantic abstracts representing the holdings.

At 708, a comparison between the first and second semantic mappings can be performed. The comparison can result in an identification of one or more areas within the technical area that either have intellectual property fences in place or have the potential to have such intellectual property fences erected, either by the user entity or by a competitor. For example, there may be areas that are similar to the identified areas 610, 612, and 614 of FIG. 6. That is, an intellectual property fence around the competitor's intellectual property holdings may not exist but the investigating entity has an opportunity to pursue building such a fence by preparing and filing a number of patent applications, for example.

In certain situations, however, the entity may not yet be in a position to prepare, let alone file any patent applications geared toward the identified spaces. For example, the entity may need to devote significantly more time and money into research before getting to that point. It is worth noting, however, that by alerting the user entity to such areas, the system is advantageously providing the entity with a direction that the entity might not have obtained otherwise.

Thus, in certain embodiments of the disclosed technology, the investigating entity can effectively identify areas in which the entity can seek to create fences in the competitor's intellectual property holdings. The investigating entity can also detect intellectual property fences being developed by a competitor within the entity's own intellectual property holdings. In certain implementations, highly significant combinations of intellectual property can be identified from the holdings of the investigating entity that can be applied in such a way so as to impact the intellectual property holdings of a competitor which are not anticipated by the investigating entity.

In certain scenarios, the investigating entity can be alerted to intellectual property that it already owns and that it may be able to apply in innovative ways to a semantic space that is identified as either being in a weak position for the investigating entity or in a strong position for one or more competitors. Thus, the investigating entity can desirably shore up existing intellectual property protection and/or expand into areas in which the entity has no more than insignificatn intellectual property protection in place.

### Exemplary Semantic Processing

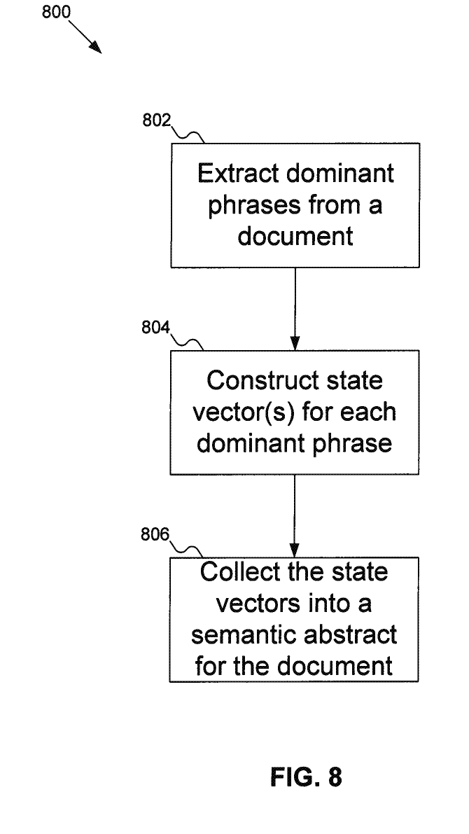

FIG. 8 shows a flowchart illustrating an example of a method 800 of constructing a semantic abstract for a document based on dominant phrase vectors. At 802, phrases (the dominant phrases) are extracted from the document. The phrases can be extracted from the document using a phrase extractor, for example. At 804, state vectors (the dominant phrase vectors) are constructed for each phrase extracted from the document. One having ordinary skill in the art will recognize that there can be more than one state vector for each dominant phrase. At 806, the state vectors are collected into a semantic abstract for the document.

Phrase extraction can generally be done at any time before the dominant phrase vectors are generated. For example, phrase extraction can be done when an author generates the document. In fact, once the dominant phrases have been extracted from the document, creating the dominant phrase vectors does not require access to the document at all. If the dominant phrases are provided, the dominant phrase vectors can be constructed without any access to the original document.

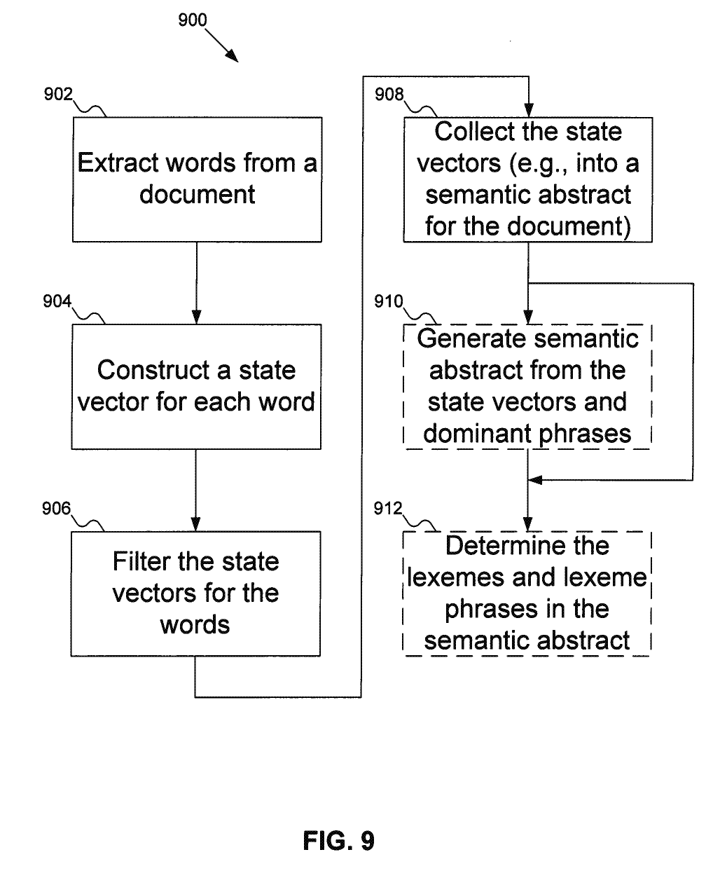

FIG. 9 shows a flowchart illustrating an example of a method 900 of constructing a semantic abstract for a document based on dominant vectors. At 902, words are extracted from the document. The words can be extracted from the entire document or from only portions of the document (such as one of the abstracts of the document or the topic sentences of the document, for example). At 904, a state vector is constructed for each word extracted from the document. At 906, the state vectors are filtered to reduce the size of the resulting set, producing the dominant vectors. Finally, at 908, the filtered state vectors are collected into a semantic abstract for the document.

FIG. 9 shows two additional steps that are also possible in the example. At 910, the semantic abstract is generated from both the dominant vectors and the dominant phrase vectors. The semantic abstract can be generated by filtering the dominant vectors based on the dominant phrase vectors, by filtering the dominant phrase vectors based on the dominant vectors, or by combining the dominant vectors and the dominant phrase vectors in some way, for example. Finally, at 912, the lexeme and lexeme phrases corresponding to the state vectors in the semantic abstract are determined.

As discussed above regarding phrase extraction in FIG. 8, the dominant vectors and the dominant phrase vectors can be generated at any time before the semantic abstract is created. Once the dominant vectors and dominant phrase vectors are created, the original document is not necessarily required to construct the semantic abstract.

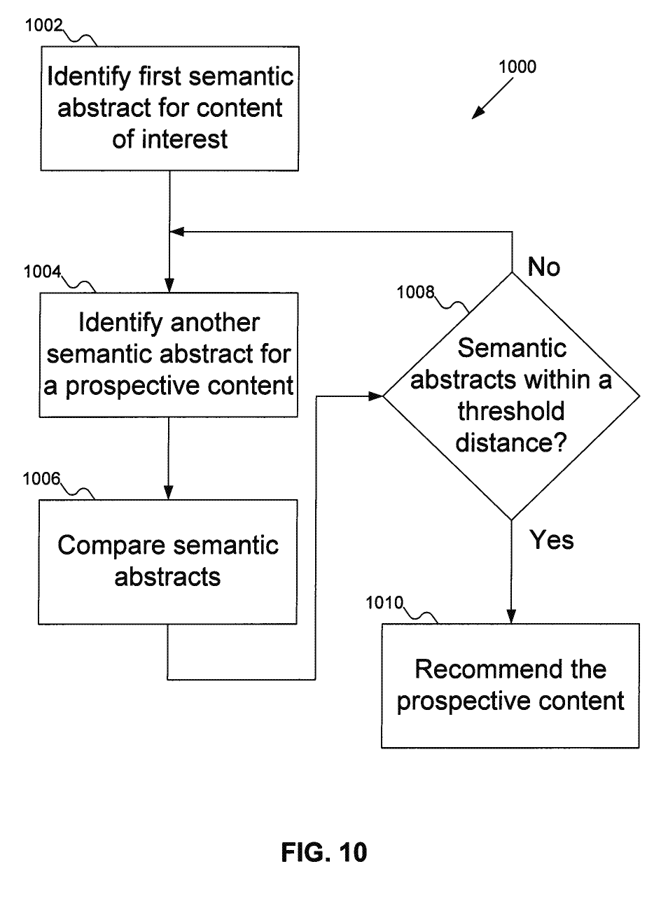

FIG. 10 shows a flowchart illustrating an example of a method 1000 of comparing two semantic abstracts and recommending a second content that is semantically similar to a content of interest. At 1002, a semantic abstract for a content of interest is identified. At 1004, another semantic abstract representing a prospective content is identified. In either or both 1002 and 1004, identifying the semantic abstract can include generating the semantic abstracts from the content, if appropriate. At 1006, the semantic abstracts are compared. Next, a determination is made as to whether the semantic abstracts are “close,” as shown at 1008. In the example, a threshold distance is used to determine if the semantic abstracts are “close.” However, one having ordinary skill in the art will recognize that there are various other ways in which two semantic abstracts can be deemed “close.” If the semantic abstracts are within the threshold distance, then the second content is recommended to the user on the basis of being semantically similar to the first content of interest, as shown at 1010. If the other semantic abstracts is not within the threshold distance of the first semantic abstract, however, then the process returns to step 1004, where yet another semantic abstract is identified for another prospective content. Alternatively, if no other content can be located that is “close” to the content of interest, processing can end.

In certain embodiments, the exemplary method 1000 can be performed for multiple prospective contents at the same time. In the present example, all prospective contents corresponding to semantic abstracts within the threshold distance of the first semantic abstract can be recommended to the user. Alternatively, the content recommender can also recommend the prospective content with the semantic abstract nearest to the first semantic abstract.

General Description of a Suitable Machine in which Embodiments of the Disclosed Technology can be Implemented

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, and the like.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices (e.g., keyboards and mice), as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, physical storage media.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An apparatus, comprising:
an information gathering module operable to retrieve information pertaining to a plurality of presently existing intellectual property activities within a particular technical field;
a semantic abstract generator operable to receive the retrieved information from the information gathering module and to generate a plurality of semantic abstracts based on the retrieved information; and
an intellectual property space identification module comprising a semantic abstract evaluation module operable to measure distances between at least some of the plurality of generated semantic abstracts.

2. The apparatus of claim 1, wherein the intellectual property space identification module comprises a blue ocean space identification module operable to identify at least one blue ocean space within the particular technical field based at least in part on the measured distances.

3. The apparatus of claim 1, wherein the intellectual property space identification module comprises a red ocean space identification module operable to identify at least one red ocean space within the particular technical field based at least in part on the measured distances.

4. The apparatus of claim 2, further comprising a blue ocean space recommendation module operable to generate and transmit a report, the report comprising recommendations pertaining to new intellectual property activities to be pursued by the user entity within the particular technical field.

5. The apparatus of claim 3, further comprising a red ocean space recommendation module operable to generate and transmit a report, the report comprising recommendations pertaining to new intellectual property activities to be pursued by the user entity within the particular technical field.

6. The apparatus of claim 1, wherein the existing intellectual property activities comprise at least one of issued patents, published patent applications, and non-patent publications.

7. The apparatus of claim 4, wherein the new intellectual property activities comprise at least one of patent applications, trademark applications, and trade secrets.

8. The apparatus of claim 5, wherein the new intellectual property activities comprise at least one of patent applications, trademark applications, and trade secrets.

9. The apparatus of claim 1, wherein responsive to a request by a user entity, the semantic abstract generator is further operable to generate a second plurality of semantic abstracts based on the plurality of existing intellectual property activities.

10. The apparatus of claim 1, further comprising a report storage module operable to store the report for future use by the user entity.

11. A computer-implemented method, comprising:
identifying a first plurality of intellectual property activities for a user entity, the first plurality of intellectual property activities pertaining to at least one particular technical field;
identifying a second plurality of intellectual property activities for at least one competitor, the second plurality of intellectual property activities pertaining to the at least one particular technical field;
generating a first plurality of semantic abstracts based on the first plurality of intellectual property activities;
generating a second plurality of semantic abstracts based on the second plurality of intellectual property activities;
performing a comparison of the first and second generated pluralities of semantic abstracts;
generating one or more recommendations based on the comparison; and
transmitting a report comprising the one or more recommendations.

12. The computer-implemented method of claim 11, wherein the one or more recommendations pertain to patent applications to be pursued by the user entity.

13. The computer-implemented method of claim 11, wherein generating one or more recommendations comprises determining at least one blue ocean space within the particular technical field.

14. The computer-implemented method of claim 11, wherein generating one or more recommendations comprises determining at least one red ocean space within the particular technical field.

15. The computer-implemented method of claim 12, wherein the one or more recommendations pertain to patent applications that can be pursued by the user entity to construct an intellectual property fence within the at least one particular technical field.

16. The computer-implemented method of claim 12, wherein the one or more recommendations pertain to patent applications that can be pursued by the user entity to avoid being fenced in by intellectual property activities of the at least one competitor.

17. The computer-implemented method of claim 11, further comprising storing the report.

18. A tangible computer-readable medium storing computer-executable instructions that, when executed by a processor, perform the computer-implemented method of claim 11.

19. A computer-implemented method, comprising:
receiving an identification of at least one particular technical field for a user entity;
identifying a plurality of intellectual property activities pertaining to the at least one particular technical field;
generating a plurality of semantic abstracts based on the plurality of intellectual property activities;
evaluating the generated plurality of semantic abstracts;
generating a report based on the evaluating; and
providing the generated report.

20. The computer-implemented method of claim 19, wherein evaluating comprises identifying at least one nullity within the generated plurality of semantic abstracts.

21. The computer-implemented method of claim 19, wherein evaluating comprises identifying at least one blue ocean space within the particular technical field.

22. The computer-implemented method of claim 19, wherein evaluating comprises identifying at least one red ocean space within the particular technical field.

23. The computer-implemented method of claim 19, wherein evaluating comprises identifying at least one opportunity for building an intellectual property fence within the particular technical field.

24. The computer-implemented method of claim 19, further comprising storing the generated report.

25. A tangible computer-readable medium storing computer-executable instructions that, when executed by a processor, perform the computer-implemented method of claim 19.
